(19) United States
(12) Patent Application Publication
(10) Pub. No.: US 2022/0269451 A1
(43) Pub. Date: Aug. 25, 2022

(54) IMAGE FORMING SYSTEM AND MANAGEMENT SERVER

(71) Applicant: KYOCERA Document Solutions Inc., Osaka-shi (JP)

(72) Inventor: Shinichi KIMURA, Osaka-shi (JP)

(21) Appl. No.: 17/668,641

(22) Filed: Feb. 10, 2022

(30) Foreign Application Priority Data
Feb. 25, 2021 (JP) 2021-028108

(51) Int. Cl. G06F 3/12

(52) U.S. Cl. CPC G06F 3/1219; G06F 3/1259; G06F 3/1285; G06F 3/1224; G06F 3/1294; G06F 3/1296

(57) ABSTRACT

The image forming system includes a user terminal device, an image forming apparatus, and a management server. The management server acquires document data from the user terminal device, specifies a current consumable item remaining amount in the image forming apparatus based on latest consumable item remaining amount information for the image forming apparatus, specifies a consumable item requirement amount in a case where a document based on the document data is printed by the image forming apparatus, sends a warning message to the user terminal device if the consumable item requirement amount is greater than the current consumable item remaining amount, and stores the document data so as to be downloadable to the second location if the consumable item requirement amount is equal to or less than the current consumable item remaining amount. The image forming apparatus downloads the document data from the management server and prints the document.

### INCORPORATION BY REFERENCE

This application is based upon and claims the benefit of priority from the corresponding Japanese Patent Application No. 2021-028108 filed on Feb. 25, 2021, the entire contents of which are incorporated herein by reference.

### BACKGROUND

The present disclosure relates to an image forming system and a management server.

In a typical system, a printer driver of a host computer connected to a printer derives the amount of ink consumed in a print job, specifies the remaining amount of ink in the printer, and displays a message indicating a lack of ink if the amount of ink consumed is greater than the remaining amount of ink.

As described above, at a certain location, a host computer connected to a printer can specify whether consumable item for print execution is sufficient in amount before print execution. However, when a user is at an organization location such as an office, it is difficult to know whether consumable item in an image forming apparatus at a remote location such as the home of the user is sufficient in amount for executing a job desired by the user. When a user attempts to execute a job at a remote location where the consumable item runs out, it is difficult to immediately replenish the consumable item.

### SUMMARY

An image forming system according to the present disclosure includes a user terminal device at a first location, an image forming apparatus at a second location, and a management server that acquires consumable item remaining amount information for the image forming apparatus. The management server acquires document data from the user terminal device, specifies the image forming apparatus corresponding to the user and specifies a current consumable item remaining amount in the image forming apparatus corresponding to the user based on the latest consumable item remaining amount information for the image forming apparatus, specifies, based on the document data, a consumable item requirement amount in a case where a document based on the document data is printed in the image forming apparatus corresponding to the user, determines whether the consumable item requirement amount is greater than the current consumable item remaining amount; sends a warning message to the user terminal device if the consumable item requirement amount is greater than the current consumable item remaining amount, and stores the document data so as to be downloadable to the second location if the consumable item requirement amount is equal to or less than the current consumable item remaining amount. The image forming apparatus downloads the document data from the management server in accordance with a user operation performed by the user at the second location and prints the document based on the document data.

A management server according to the present disclosure includes a document management processor that acquires document data from a user terminal device at a first location, and a consumable item remaining amount information acquiring unit for acquiring consumable item remaining amount information of image forming apparatus at a second location. The document management processor specifies the image forming apparatus corresponding to the user, specifies the current consumable item remaining amount in image forming apparatus corresponding to the user based on the latest consumable item remaining amount information for the image forming apparatus, specifies, based on the document data, the consumable item requirement amount in a case where a document based on the document data is printed in image forming apparatus corresponding to the user, determines whether the consumable item requirement amount is greater than the current consumable item remaining amount, sends a warning message to the user terminal device if the consumable item requirement amount is greater than the current consumable item remaining amount, and stores the document data so as to be downloadable to the second location if the consumable item requirement amount is equal to or less than the current consumable item remaining amount.

### BRIEF DESCRIPTION OF THE DRAWINGS

FIG. 1 shows a configuration of an image forming system according to an embodiment of the present disclosure.

FIG. 2 shows a configuration of the user terminal device 11 in FIG. 1.

FIG. 3 shows a configuration of the management server 12 in FIG. 1.

FIG. 4 shows a configuration of image forming apparatus 21 shown in FIG. 1.

FIG. 5 shows a job execution sequence in the image forming system shown in FIG. 1.

### DETAILED DESCRIPTION

Hereinafter, embodiments of the present disclosure will be described with reference to the figures.

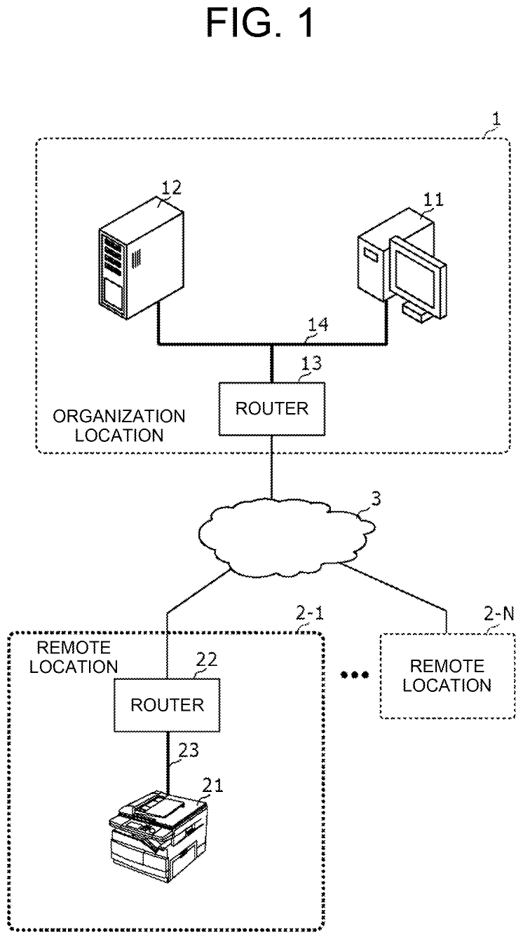

FIG. 1 shows a configuration of an image forming system according to the embodiment of the present disclosure. The image forming system shown in the FIG. 1 includes user terminal devices 11, management servers 12, routers 13, and local networks 14 at the organization location 1. The image forming system further includes an image forming apparatus 21, a router 22, and a local network 23 at each of one or more remote locations 2-1 to 2-n. The image forming system executes VPN communication (virtual private network communication) between an organization location 1 and each remote location 2-i via a wide area network 3 (the Internet or the like).

For example, the organization location 1 is an office of a company, and a remote location 2-i (“i” is an integer of 1 to N; the same applies hereinafter) is the home of an employee (user) of the company.

The user terminal device 11 is a personal computer or the like and is connected to the local network 14. The management server 12 is a personal computer or a server machine having functions of a file server, an active directory server and the like, and is connected to the local network 14. The router 13 is a communication device that has, for example, a VPN server function and connects the local network 14 and the wide area network 3. Note that the local network 14 is a wired LAN (Local Area Network), a wireless LAN, or the like.

The image forming apparatus 21 is a printer, a multifunction peripheral, or the like, and is connected to the local network 23. The image forming apparatus 21 executes a job (print job, scan-to-job, or the like) requested by the user. The router 22 is the communication device that connects the local network 23 and the wide area network 3. The local network 23 is a wired LAN, a wireless LAN, or the like.

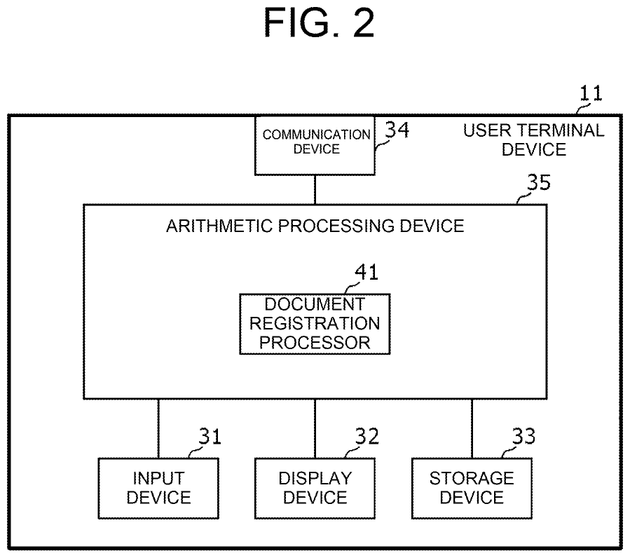

FIG. 2 shows the configuration of the user terminal device 11 in FIG. 1.

As shown in FIG. 2, the user terminal device 11 includes an input device 31, a display device 32, a storage device 33, a communication device 34, and an arithmetic processing device 35.

The input device 31 is a hard key, a touch panel, or the like, detects a user operation by a user, and outputs information indicating the user operation. The display device 32 is a liquid crystal display or the like and displays various kinds of information to the user. Note that the input device 31 and the display device 32 may be built in the user terminal device 11 or may be connected to the user terminal device 11 as an external device.

The storage device 33 is a rewritable nonvolatile storage device such as a hard disk and a flash memory, and stores programs and data.

The communication device 34 is connected to the local network 23 and performs data communication with other devices via the local network 23.

The arithmetic processing device 35 includes a computer that executes various programs, an ASIC (Application Specific Integrated Circuit), and the like, and operates as various processors by the computer, an ASIC, and the like. Here, the arithmetic processing device 35 operates as a document registration processor 41.

The document registration processor 41 specifies document data (and print job setting information) specified by the user operation on the input device 31 and sends the specified document data (and the print job setting information) as a document registration request to the management server 12 via the communication device 34.

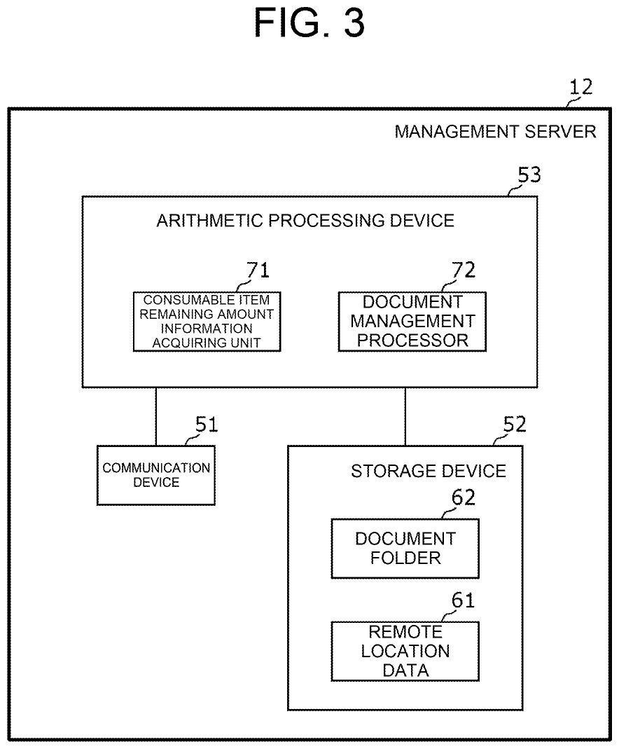

FIG. 3 shows the configuration of the management server 12 in FIG. 1.

As shown in FIG. 3, the management server 12 includes a communication device 51, a storage device 52, and an arithmetic processing device 53.

The communication device 51 is connected to the local network 23 and performs data communication with other devices via the local network 23.

The storage device 52 is a rewritable nonvolatile storage device such as a hard disk and a flash memory and stores programs and data. In the storage device 52, remote location data 61 is stored, and a document folder 62 is set.

The remote location data 61 includes, for each user, the user (user ID), the image forming apparatus 21 (network identification information and the like) of the remote location 2-i corresponding to the user, and the consumable item remaining amount information for the image forming apparatus 21 of the remote location 2-i corresponding to the user, in association with each other. The consumable item remaining amount information is information indicating a usable remaining amount of consumable item (color materials such as toner, a printing paper, photosensitive drum, and the like) required for printing in the image forming apparatus 21 of the remote location 2-i.

The arithmetic processing device 53 includes a computer that executes various programs, ASIC, and the like and acts as various processors in the computer, ASIC, and the like. Here, the arithmetic processing device 53 operates as a consumable item remaining amount information acquiring unit 71 and a document management processor 72.

The consumable item remaining amount information acquiring unit 71 acquires the consumable item remaining amount information for the image forming apparatus 21 in each remote location 2-i and updates the consumable item remaining amount information in the remote location data 61 with the acquired consumable item remaining amount information.

The consumable item remaining amount information acquiring unit 71 acquires consumable item remaining amount information in the following manner, for example.

The consumable item remaining amount information acquiring unit 71 may send a transmission request for the consumable item remaining amount information to the image forming apparatus 21 at a first timing and receive the consumable item remaining amount information from the image forming apparatus 21 as a response to the transmission request. The first timing for transmission of the transmission request is (a) a timing at which document data is acquired by the management server 12, or (b) a timing that is specified by the user and repeatedly arrives at a specific time interval.

The image forming apparatus 21 specifies the consumable item remaining amount of the image forming apparatus 21 autonomously at a second timing, and sends the consumable item remaining amount information to the management server 12. The consumable item remaining amount information acquiring unit 71 receives the consumable item remaining amount information sent from the image forming apparatus 21. The second timing is at least one of (a) a print job completion timing of the image forming apparatus 21 (that is, when the consumable item remaining amount is changed); (b) a sleep mode shift timing of the image forming apparatus 21; and (c) a shutdown timing of the image forming apparatus 21.

The controller 91 of the image forming apparatus 21 stores the consumable item remaining amount information of the image forming apparatus 21 in a portable storage device such as a USB memory and an SD card, using an interface. The user carries the portable storage device, moves from a remote location 2-i to an organization location 1, connects to the management server 12, and a consumable item remaining amount information acquiring unit 71 reads and acquires consumable item remaining amount information from the portable storage device. Alternatively, the user connects the portable storage device to the user terminal device 11 and operates the user terminal device 11 to cause the user terminal device 11 to read and send the consumable item remaining amount information to the management server 12. The consumable item remaining amount information acquiring unit 71 receives and acquires the sent consumable item remaining amount information.

The document management processor 72 also acquires the document data (and the print job setting information) of the user from the user terminal device 11 at the organization location 1. Although the print job setting information is acquired together with the document data here, the print job setting information does not have to be acquired and may be specified by the user at the time of execution of the print job. Document data is image data of a document image. The print job setting information indicates a paper size setting, a color/monochrome setting, a one sided/two sided setting, an aggregate print setting, the number of copies, and the like.

Furthermore, the document management processor 72 executes:

(a) specifying, upon receiving a document registration request, a user (user ID) specified by the received document registration request;

(b) specifying the image forming apparatus 21 corresponding to the specified user based on the remote location data 61;

(c) specifying the latest consumable item remaining amount information for the image forming apparatus 21 corresponding to the specified user based on the remote location data 61;

(d) specifying a current consumable item remaining amount in the image forming apparatus 21 corresponding to the specified user based on the specified latest consumable item remaining amount information;

(e) specifying, based on the document data (and the print job setting information), a consumable item requirement amount in a case where a document based on the document data is printed in the image forming apparatus 21 corresponding to the specified user;

(f) determining whether the specified consumable item requirement amount is greater than the current consumable item remaining amount;

(g1) sending a warning message to the user terminal device 11 if the specified consumable item requirement amount is greater than the current consumable item remaining amount;

(g2) storing the document data (and the print job setting information) so as to be downloadable to the remote location 2-i if the specified consumable item requirement amount is equal to or less than the current consumable item remaining amount.

The warning message indicates that, with respect to the consumable item, the specified consumable item requirement amount is greater than the current consumable item remaining amount described above and indicates that the indicated consumable item is insufficient in amount.

In the present embodiment, the document data (and the print job setting information) is stored in a specific document folder 62 in association with the user or the image forming apparatus 21. Note that the specific document folder 62 may be a shared folder or a user-specific folder specified by the user (a folder created by the user with a specific name). The document management processor 72 has a file server function of a specific communication protocol such as a web server. When the communication device 51 accepts the transmission request in accordance with the specific communication protocol, the document management processor 72 reads the document data (and the print job setting information) of the user specified by the transmission request from the specific document folder 62 and sends the read document data as a response to the communication device 51. As a result, the image forming apparatus 21 of the remote location 2-i can download the document data (and the print job setting information) in the specific document folder 62.

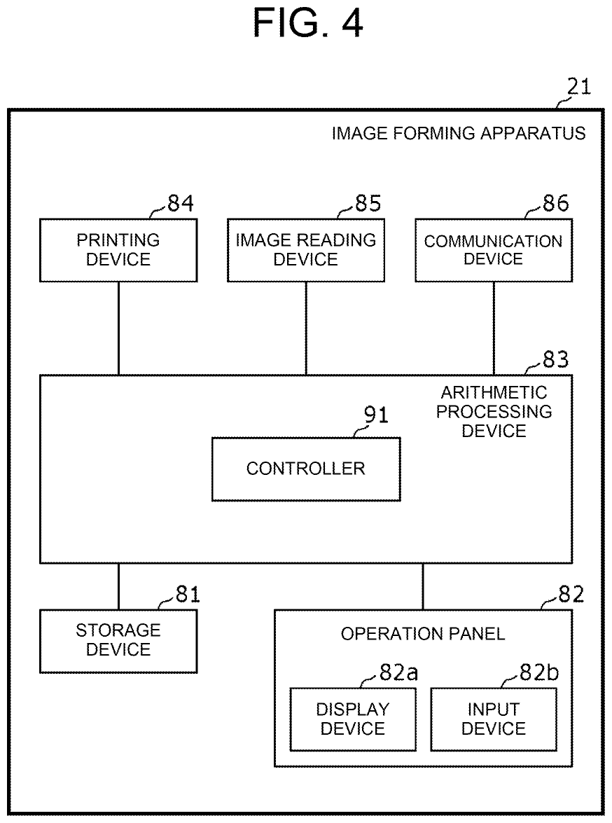

FIG. 4 shows the configuration of image forming apparatus 21 shown in FIG. 1. The image forming apparatus 21 shown in the FIG. 4 includes a storage device 81, an operation panel 82, an arithmetic processing device 83, a printing device 84, an image reading device 85, and a communication device 86.

The storage device 81 is a nonvolatile rewritable storage device such as a flash memory. The storage device 81 stores a program and data.

The operation panel 82 is arranged on an upper front side or the like of the housing of the image forming apparatus 21 and includes a display device 82a such as a liquid crystal display, and an input device 82b such as hard keys and a touch panel. The display device 82a displays various screens for the user, and the input device 82b receives a user operation input by the user.

The arithmetic processing device 83 is a computer including a CPU (Central Processing Unit), a ROM (Read Only Memory) and a RAM (Random Access Memory), and operates as various processors by loading a program stored in the ROM or the storage device 52 into the RAM and executing the program by the CPU. The arithmetic processing device 83 operates as a controller 91.

The printing device 84 prints an object image (such as a document image) on a print paper based on image data. The image reading device 85 optically reads a document image from a document to generate image data of the document image. The communication device 86 is connected to the local network 23 and performs data communication with the router 22 or the like.

The controller 91 executes a requested job by controlling internal devices such as the printing device 84, the image reading device 85, and the communication device 86 in accordance with a job request received from a terminal device (not illustrated) such as a personal computer connected to the local network 23 via the user operation on the operation panel 82 or the communication device 86. The controller 91 stores and manages the consumable item remaining amounts of the consumable items of the printing device 84 in the storage device 81 and updates the consumable item remaining amounts in a case where printing is executed.

For example, the controller 91 downloads document data (and print job setting information) corresponding to the user stored in the management server 12 of the organization location 1 according to the job request based on the user operation at the remote location 2-i (user operation on the terminal device connected to the image forming apparatus 21 or the local network 23). The controller 91 executes the print job based on the downloaded document data (and the print job setting information) and causes the printing device 84 to execute printing.

At that time, for example, the controller 91 may download from the management server 12 a list of document data stored in the document folder 62 corresponding to the user who has logged in to the image forming apparatus 21 and display it. In such a case, the controller 91 may select document data from the displayed list and download the selected document data (and corresponding print job setting information) in accordance with a user operation.

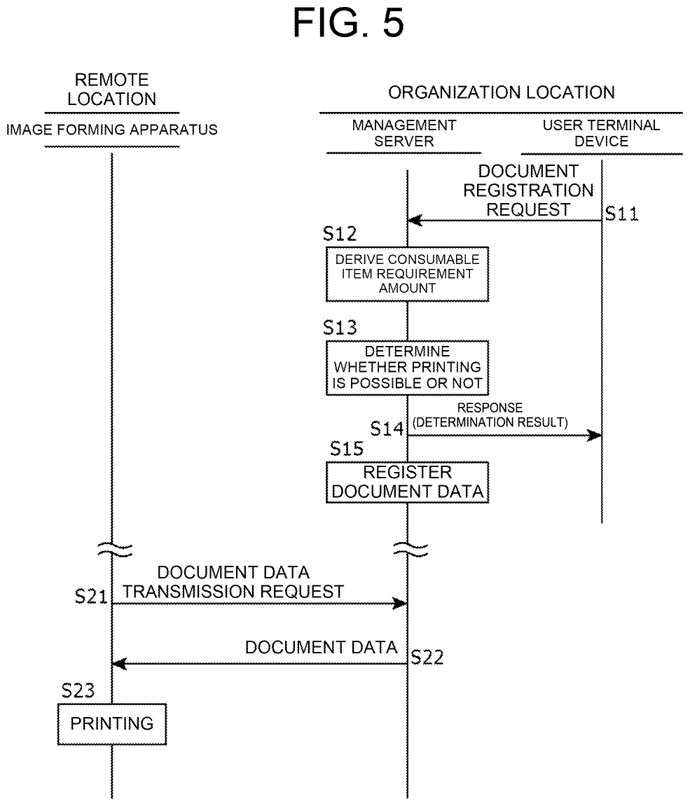

Next, operations of the above described system will be described. FIG. 5 shows a job execution sequence in the image forming system shown in FIG. 1.

The management server 12 repeatedly acquires the consumable item remaining amount information as described above for each image forming apparatus 21 registered in the remote location data 61 and updates the consumable item remaining amount information in the remote location data 61 with the acquired consumable item remaining amount information.

Next, while the user is at the organization location 1, the user operates the user terminal device 11 to register the document data (and the print job setting information) in the management server 12. At that time, as step S11, the user terminal device 11 sends the document data (and the print job setting information) specified by the user to the management server 12 as a document registration request in accordance with a user operation. In step S12, upon receiving the document data (and the print job setting information) as the document registration request, the management server 12 specifies the image forming apparatus 21 corresponding to the user who has sent the document data (and the print job setting information) as described above, and derives the consumable item requirement amount for the specified image forming apparatus 21. In step S13, the management server 12 reads out the consumable item remaining amount information for the specified image forming apparatus 21 to specify the consumable item remaining amount and determines whether the consumable item requirement amount is greater than the consumable item remaining amount (that is, whether printing is possible).

In step S14, based on the determination in step S13, if the consumable item requirement amount is greater than the consumable item remaining amount (i.e. if printing is possible), the management server 12 sends a response indicating that printing is possible to the user terminal device 11. In step S15, the management server 12 stores the document data (and the print job setting information) in the specific document folder 62.

In step S14, based on the determination in step S13, if the consumable item requirement amount is equal to or less than the consumable item remaining amount (that is, if printing is not possible), the management server 12 sends a response (the above described warning message) indicating that printing is not possible to the user terminal device 11, and does not store the document data (and the print job setting information) in the specific document folder 62.

After the document data (and the print job setting information) is registered in the management server 12 as described above, when the user is at the remote location 2-i, printing based on the document data (and the print job setting information) registered in the management server 12 is performed at an image forming apparatus 21 of the remote location 2-i. At this time, at step S21, the image forming apparatus 21 of the remote location 2-i sends a user's document data transmission request to the management server 12 in accordance with a user operation. Upon receiving the transmission request, in step S22, the management server 12 sends the document data (and the print job setting information) of the user specified by the transmission request to the image forming apparatus 21 of the remote location 2-i. Upon receiving the document data (and the print job setting information), in step S23, the image forming apparatus 21 executes printing based on the document data (and the print job setting information) (step S23).

As described above, according to the above embodiment, the management server 12 acquires the consumable item remaining amount information for the image forming apparatus 21 at the remote location 2-i. The management server 12 executes:

(a) acquiring document data of a user from the user terminal device 11 at an organization location 1

(b) specifying the image forming apparatus 21 corresponding to a user and specifying a current consumable item remaining amount in the image forming apparatus 21 corresponding to the user based on the latest consumable item remaining amount information for the specified image forming apparatus 21;

(c) specifying, based on the document data, a consumable item requirement amount in a case where a document based on the document data is printed in the image forming apparatus 21 corresponding to the user;

(d) determining whether the consumable item requirement amount is greater than the current consumable item remaining amount;

(e1) sending a warning message to the user terminal device 11 if the consumable item requirement amount is greater than the current consumable item remaining amount;

(e2) storing the document data so as to be downloadable to the remote location 2-i if the consumable item requirement amount is equal to or less than the current consumable item remaining amount.

Thus, when the user is at the organization location 1, the user can know in advance that the consumable item in the image forming apparatus 21 at the remote location 2-i will be insufficient in amount. Therefore, the user can prepare consumables before printing at the remote location 2-i, and it is suppressed that job execution becomes difficult due to exhaustion of the consumable items in the image forming apparatus 21 at the remote location 2-i.

Note that various changes and modifications to the above described embodiment will be apparent to those skilled in the art. Such changes and modifications may be made without departing from the spirit and scope of the subject matter and without diminishing its FIG. advantages. Thus, it is intended that such changes and modifications be included within the scope of the claims FIG.

For example, in the above described embodiment, when document data is already registered for the user who has sent a document registration request, the document management processor 72 of the management server 12 may derive a value obtained by adding the consumable item requirement amount of the document data of the document registration request and the consumable item requirement amount of the already registered document data, and determine whether the consumable item requirement amount (sum value) is greater than the consumable item remaining amount predicted value.

Further, in the above described embodiment, when the document management processor 72 of the management server 12 updates the already registered document data based on the document registration request (that is, when the file name of the document data of the document registration request and the file name of the registered document data are the same), the document management processor 72 may update the document data without determining whether the consumable item requirement amount is greater than the consumable item remaining amount at the present time. If the difference in size between the already registered document data and the document data of the document registration request is less than the specific value, the document data may be updated without determining whether the consumable item requirement amount is greater than the current consumable item remaining amount; otherwise, it may be determined whether the consumable item requirement amount is greater than the current consumable item remaining amount. In this case, the document data of the document registration request may be registered if the consumable item requirement amount is equal to or less than the current consumable item remaining amount; and otherwise the document data of the document registration request may not be registered if not.

Furthermore, in the above described embodiment, the functions of the management server 12 (the consumable item remaining amount information acquiring unit 71 and the document management processor 72) may be provided for the user terminal device 11 without providing the management server 12 separately from the user terminal device 11.

The present disclosure can be applied to, for example, an image forming system including an image forming apparatus.

What is claimed is:

1. An image forming system, comprising:
a user terminal device at a first location;
an image forming apparatus at the second location; and
a management server that acquires consumable item remaining amount information for the image forming apparatus, the management server
acquiring document data from the user terminal device,
specifying the image forming apparatus corresponding to a user and specifying a current consumable item remaining amount in the image forming apparatus corresponding to the user based on latest consumable item remaining amount information for the image forming apparatus,
specifying, based on the document data, a consumable item requirement amount in a case where a document based on the document data is printed in the image forming apparatus corresponding to the user,
determining whether the consumable item requirement amount is greater than the current consumable item remaining amount,
sending a warning message to the user terminal device if the consumable item requirement amount is greater than the current consumable item remaining amount, and
storing the document data so as to be downloadable to the second location if the consumable item requirement amount is equal to or less than the current consumable item remaining amount, wherein
the image forming apparatus downloads the document data from the management server in accordance with a user operation by the user at the second location and prints the document based on the document data.

2. The image forming system according to claim 1, wherein
the management server stores the document data in a specific folder, and
the image forming apparatus downloads the document data in the specific folder.

3. The image forming system according to claim 1, wherein
the management server acquires print job setting information together with the document data from the user terminal device and specifies the consumable item requirement amount based on the document data and the print job setting information.

4. The image forming system according to claim 1, wherein
the management server acquires the consumable item remaining amount information from the image forming apparatus at a first timing, and
the first timing is a timing at which the document data is acquired, or a timing that is specified by the user and repeatedly arrives at a specific time interval.

5. The image forming system according to claim 1, wherein
the image forming apparatus autonomously specifies the consumable item remaining amount in the image forming apparatus at a second timing and sends the consumable item remaining amount information to the management server, and
the second timing is at least one of a print job completion timing of the image forming apparatus, a sleep mode shift timing of the image forming apparatus, and a shutdown timing of the image forming apparatus.

6. The image forming system according to claim 1, wherein
the image forming apparatus stores the consumable item remaining amount information in a portable storage device, and
the management server acquires the consumable item remaining amount information read from the portable storage device.

7. The image forming system according to claim 1, wherein
when updating the document data already stored, the management server updates the document data without determining whether the consumable item requirement amount is greater than the current consumable item remaining amount.

8. The image forming system according to claim 7, wherein
the management server
updates the document data without determining whether the consumable item requirement amount is greater than the current consumable item remaining amount if a difference in size between the document data already stored and the document data to be updated is less than a specific value,
determines whether the consumable item requirement amount is greater than the current consumable item remaining amount if the difference in size between the document data already stored and the document data to be updated is not less than the specific value, and
avoids updating the document data if the consumable item requirement amount is greater than the current consumable item remaining amount and updates the document data if the consumable item requirement amount is equal to or less than the current consumable item remaining amount.

9. A management server, comprising:
a document management processor that acquires document data from a user terminal device at a first location, and
a consumable item remaining amount information acquiring unit that acquires consumable item remaining amount information for an image forming apparatus at a second location,
the document management processor
specifying the image forming apparatus corresponding to a user,
specifying a current consumable item remaining amount in the image forming apparatus corresponding to the user based on latest consumable item remaining amount information for the image forming apparatus,
specifying, based on the document data, a consumable item requirement amount in a case where a document based on the document data is printed in the image forming apparatus corresponding to the user,
determining whether the consumable item requirement amount is greater than the current consumable item remaining amount,
sending a warning message to the user terminal device if the consumable item requirement amount is greater than the current consumable item remaining amount, and
storing the document data so as to be downloadable to the second location if the consumable item requirement amount is equal to or less than the current consumable item remaining amount.
